(19) United States
(12) Patent Application Publication
(10) Pub. No.: US 2023/0228298 A1
(43) Pub. Date: Jul. 20, 2023

(54) COUPLER ASSEMBLY FOR REMOVING BUSHING PINS

(71) Applicant: Tiger Tool International Incorporated, Abbotsford (CA)

(72) Inventor: Michael Andrews, Bellingham, WA (US)

(73) Assignee: Tiger Tool International Incorporated, Abbotsford, BC (CA)

(21) Appl. No.: 18/149,798

(22) Filed: Jan. 4, 2023

Related U.S. Application Data
(60) Provisional application No. 63/266,502, filed on Jan. 6, 2022.

(51) Int. Cl. F16C 43/00; F16C 33/04

(52) U.S. Cl. CPC F16C 43/00; F16C 33/04

(57) ABSTRACT

A coupler assembly for engaging a bushing pin of a bushing assembly, the bushing pin defining at least one bushing pin recess has a coupler collar and at least one coupler pin. The coupler collar defines a coupler through hole and at least one coupler pin passageway. The at least one coupler pin is adapted to be inserted at least partly through the at least one coupler pin passageway. With at least a portion of the bushing pin within the coupler through hole and the at least one bushing pin recess in a desired orientation relative to the at least one coupler pin passageway, the at least one coupler pin is inserted into the at least one coupler pin passageway such that the at least one coupler pin engages the at least one bushing pin recess to inhibit relative movement between the bushing pin and the coupler collar.

### RELATED APPLICATIONS

This application (Attorney's Ref No. P220348) claims benefit of U.S. Provisional Application Ser. No. 63/266,502 filed Jan. 6, 2022, the contents of which are incorporated herein by reference.

### TECHNICAL FIELD

The present invention relates to systems and methods for removing a bushing pin from a bushing housing and, in particular, to bushing pin removal systems and methods for bushing pins without a transverse through hole.

### BACKGROUND

Bushing assemblies typically comprise a bushing housing, a bushing sleeve arranged within the bushing housing, and a bushing pin arranged within the bushing sleeve. Maintenance and/or repair of a bushing assembly often requires removal of the bushing pin from the bushing assembly. A removal force must be applied on the bushing pin relative to the bushing housing and/or bushing sleeve to displace the bushing pin relative to the bushing housing and/or bushing sleeve. To apply this removal force, the bushing pin must be securely gripped.

A class of bushing pins is configured without a properly placed lateral through opening such that secure gripping of the bushing pin is difficult. The need exists for coupler assemblies and busing pin removal systems that facilitate the removal of bushing pins that are difficult to grip securely.

### SUMMARY

The present invention may be embodied as a coupler assembly for engaging a bushing pin of a bushing assembly, where the bushing pin defines at least one bushing pin recess. In this example embodiment, the coupler assembly comprises a coupler collar and at least one coupler pin. The coupler collar defines a coupler through hole and at least one coupler pin passageway. The at least one coupler pin is adapted to be inserted at least partly through the at least one coupler pin passageway. With at least a portion of the bushing pin within the coupler through hole and the at least one bushing pin recess in a desired orientation relative to the at least one coupler pin passageway, the at least one coupler pin is inserted into the at least one coupler pin passageway such that the at least one coupler pin engages the at least one bushing pin recess to inhibit relative movement between the bushing pin and the coupler collar.

The present invention may also be embodied as a method of removing a bushing pin defining at least one bushing pin recess from a bushing assembly. In this example embodiment, the method comprising the following steps. A coupler collar defining a coupler through hole and at least one coupler pin passageway is provided. At least one coupler pin adapted to be inserted at least partly through the at least one coupler pin passageway is provided. With at least a portion of the bushing pin within the coupler through hole and the at least one bushing pin recess in a desired orientation relative to the at least one coupler pin passageway, the at least one coupler pin is inserted into the at least one coupler pin passageway such that the at least one coupler pin engages the at least one bushing pin recess to inhibit relative movement between the bushing pin and the coupler collar.

The present invention may also be embodied as a system for removing a bushing pin defining at least one bushing pin recess from a bushing assembly comprising a bushing housing. In this example embodiment, the system comprises a coupler collar, at least one coupler pin, and an actuator. The coupler collar defines a coupler through hole and at least one coupler pin passageway. The at least one coupler pin is adapted to be inserted at least partly through the at least one coupler pin passageway. With at least a portion of the bushing pin within the coupler through hole and the at least one bushing pin recess in a desired orientation relative to the at least one coupler pin passageway, the at least one coupler pin is inserted into the at least one coupler pin passageway such that the at least one coupler pin engages the at least one bushing pin recess to inhibit relative movement between the bushing pin and the coupler collar. The actuator is operated to displace the coupler relative to the bushing housing to remove the bushing pin from the bushing assembly.

### BRIEF DESCRIPTION OF THE DRAWINGS

FIG. 1 is a perspective exploded view of a first example coupler assembly for removing a bushing pin;

FIG. 2 is a perspective view illustrating the first example coupler assembly prior to connection to an example bushing pin of an example bushing assembly;

FIG. 3 is a top plan view illustrating the first example coupler assembly prior to connection to the example bushing pin of the example bushing assembly;

FIG. 4 is a top plan view illustrating the first example coupler assembly connected to the example bushing pin of the example bushing assembly;

FIG. 5 is a section view taken along lines 5-5 in FIG. 3;

FIG. 6 is a section view taken along lines 6-6 in FIG. 4;

FIG. 7 is a section view taken along a plane extending through a longitudinal axis of the bushing pin illustrating the engagement of first example coupler assembly to the example bushing pin of the example bushing assembly;

FIG. 8 is a partial section taken along a plane extending through a longitudinal axis of the bushing pin illustrating a first step of a process of connecting the coupler assembly to an example displacement system;

FIGS. 9-10 illustrate the process of connecting the coupler assembly to the example displacement system;

FIGS. 11 and 12 illustrate a process of operating the displacement system to remove the bushing pin from a bushing housing of the bushing assembly; and

FIG. 13 illustrates the bushing pin removed from the bushing housing.

### DETAILED DESCRIPTION

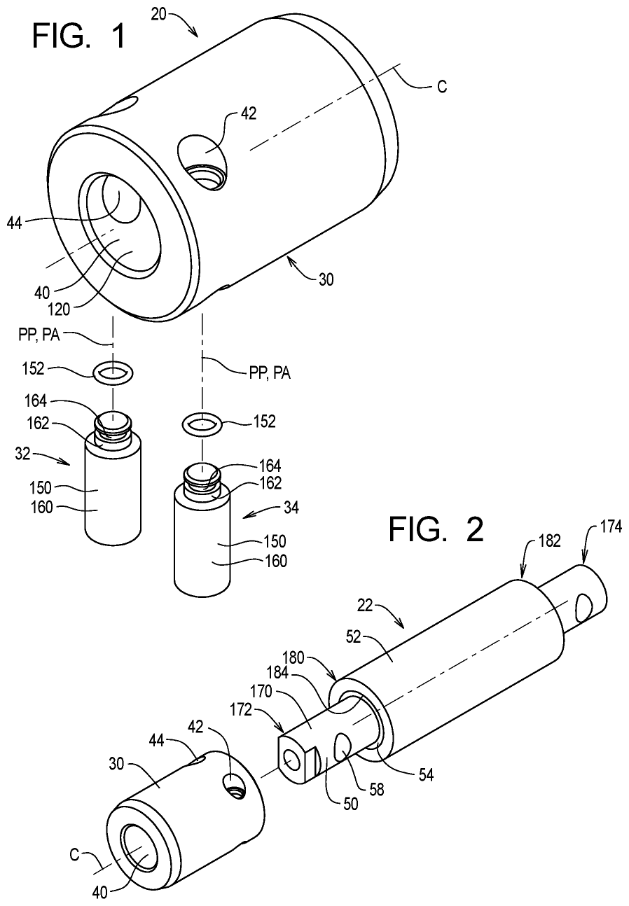

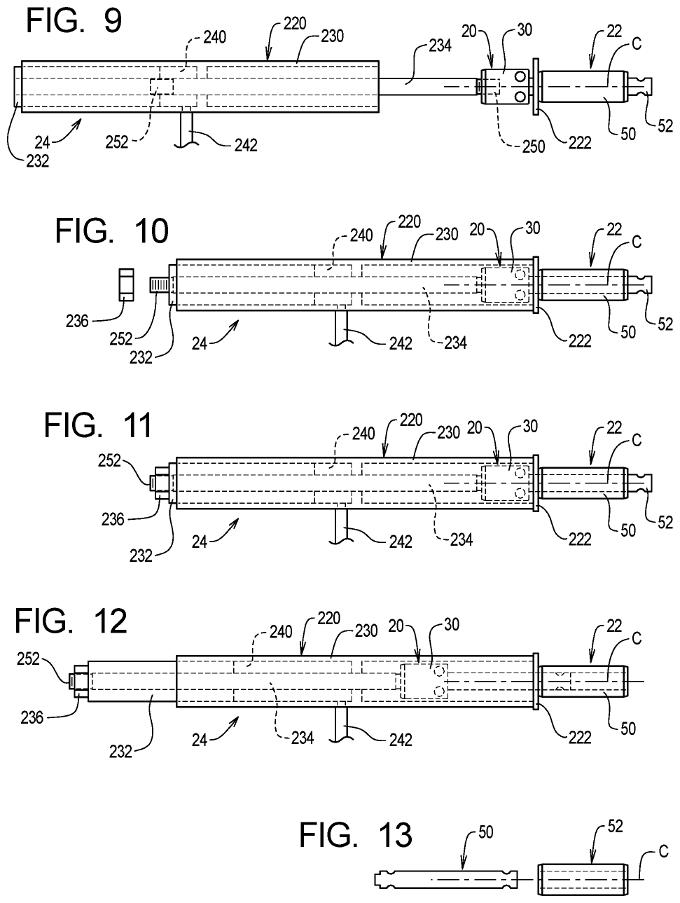

Referring initially to FIGS. 1 and 2 of the drawing, depicted therein is a first example coupler assembly 20 of the present invention. FIG. 2 further illustrates an example bushing assembly 22 to be disassembled using the first example coupler assembly 20. FIGS. 9-13 illustrate an example displacement system 24 that may be used to act on the first example coupler assembly 20 and the example bushing assembly 22 to disassemble the bushing assembly 22. The example bushing assembly 22 and the example displacement system 24 are or may be conventional and are depicted and described herein to that extent helpful to a full understanding of the construction and operation of the present invention.

The first example coupler assembly 20 comprises a coupler collar 30 and first and second coupler pin assemblies 32 and 34. The coupler collar 30 defines a collar through hole 40 and first and second coupler pin passageways 42 and 44. The example bushing assembly 22 comprises an example bushing pin 50, an example bushing housing 52, and an example bushing sleeve 54. The example bushing pin 50 defines first and second bushing pin recesses 56 and 58.

The coupler collar 30 is arranged such that a portion of the bushing pin 50 is within the coupler through hole 40. The coupler collar 30 is then further arranged such that the first and second coupler pin passageways 42 and 44 are in a desired orientation relative to the first and second bushing pin recesses 56 and 58. The first and second coupler pin assemblies 32 and 34 are then arranged within the first and second coupler pin passageways 42 and 44 such that the first and second coupler pin assemblies 32 and 34 engage the first and second bushing pin recesses 56 and 58. The displacement system 24 is then engaged with the first example coupler collar 30 and the example bushing housing 52 and operated to force the bushing pin 50 out of the bushing housing 52.

With the foregoing general understanding of the construction and operation of the present invention in mind, the details of construction and operation of the first example coupler assembly 20 will now be described in further detail.

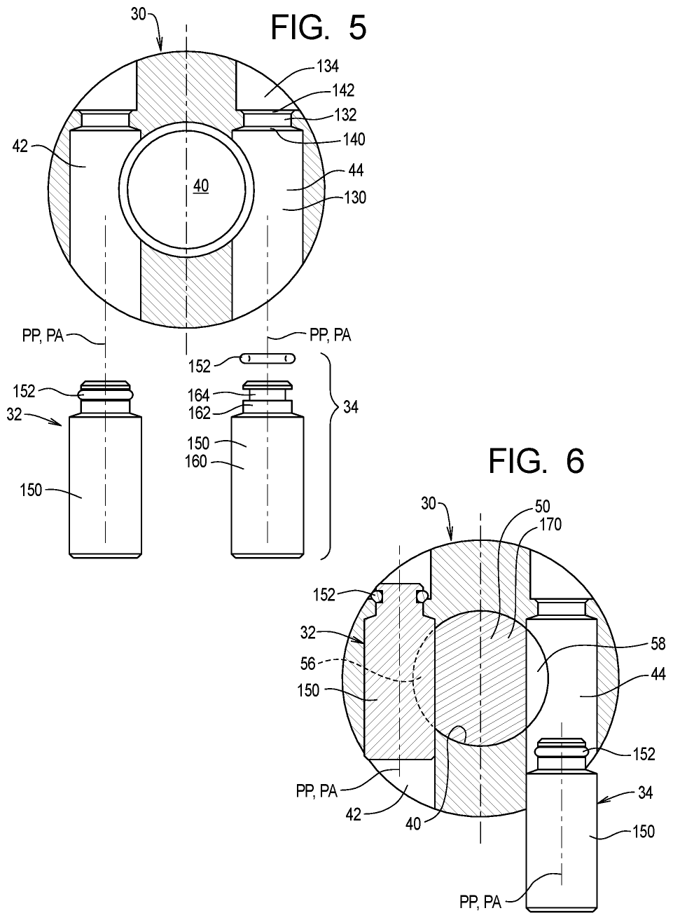

The example coupler collar 30 defines a coupler axis C. The collar through hole 40 of the example coupler collar 30 is aligned with the coupler axis C and defines a receiving portion 120 and a threaded portion 122. The example first and second coupler pin passageways 42 and 44 are the same, and the same reference characters will be used in connection with first and second coupler pin passageways 42 and 44 for brevity and clarity. However, the first and second coupler pin passageways 42 and 44 may be different, and, in some use environments, only one couple pin passageway may be used. As shown in FIG. 5, each of the example first and second coupler pin passageways 42 and 44 defines a coupler pin passageway PP, first, second, and third coupler pin through hole surfaces 130, 132, and 134, and first and second transition surfaces 140 and 142. A diameter of the example third coupler pin through hole surface 134 is greater than a diameter of the example second coupler pin through hole surface 132 and less than a diameter of the example first coupler pin through hole surface 130. The transition surfaces 140 and 142 extend at an angle to the coupler axis C.

The example first and second coupler pin assemblies 32 and 34 are the same, and the same reference characters will be used in connection with the first and second coupler pin assemblies 32 and 34 for brevity and clarity. However, the first and second coupler pin assemblies 32 and 34 may be different, and, in some use environments, only one coupler pin assembly may be used. Typically, one coupler pin assembly is provided for each coupler pin passageway provided. The example coupler pin assemblies 32 and 34 each comprises a coupler pin 150 and an O-ring 152. Each of the example coupler pins 150 defines a pin axis PA, a first coupler pin portion 160, a second coupler pin portion 162, and coupler pin recess 164. A diameter of the example second coupler pin portion 162 is less than a diameter of the first coupler pin portion 160, and the example coupler recess 164 is formed on the second coupler pin portion 162.

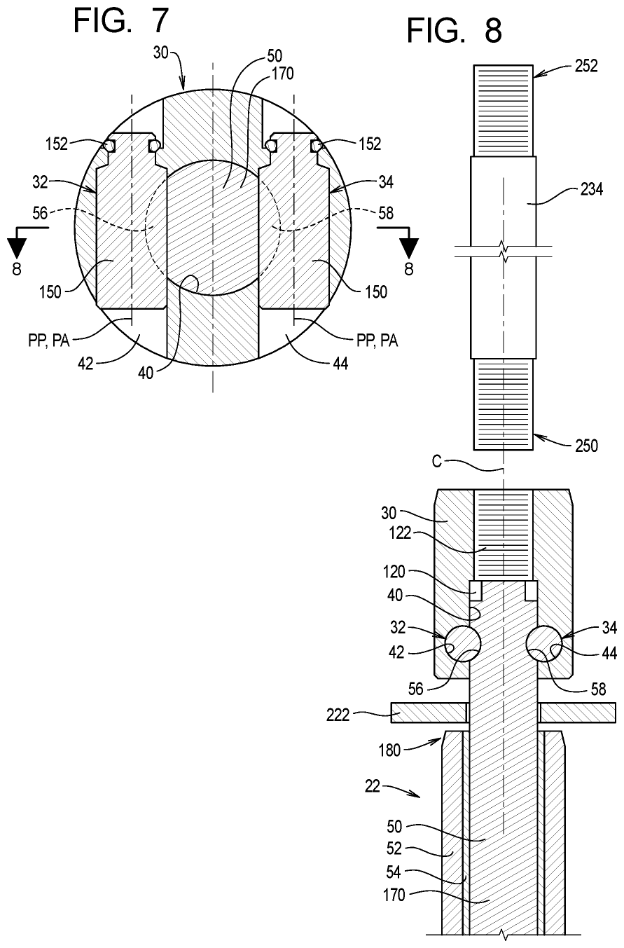

The example coupler pins 150 are sized and dimensioned such that the coupler pin assemblies 32 and 34 are snugly received within the coupler pin passageways 42 and 44 as shown in FIG. 7.

The example O-rings 152 are sized and dimensioned to be arranged partly within the example coupler recesses 164 such that the O-rings 152 are supported by the coupler pins 150 during normal use. The example O-rings 152 are further sized and dimensioned such that, when the coupler pins 150 are in a desired position relative to the coupler pin passageways 42, 44, the O-rings 152 engage the second transition surfaces 142 to maintain the coupler pins 150 in the desired position. Accordingly, as shown in FIGS. 5 and 6, the example O-rings 152 are resilient to allow for manual assembly and disassembly of the coupler pin assemblies 32 and 34 to the coupler collar 30 and to hold the coupler pin assemblies 32 and 34 prior to and during removal of the bushing pin 50 from the bushing pin housing 52.

The example bushing pin 50 defines a bushing pin shaft 170 defining a bushing pin proximal end 172 and a bushing pin distal end 174. The exact configuration of the bushing pin 50 is determined by its normal use, and the example bushing pin 50 defines the first and second bushing pin recesses 56 and 58 adjacent to the busing pin proximal end 172. The bushing housing 52 defines a bushing housing proximal end 180, a bushing housing pin distal end 182, and a bushing pin through hole 184. During normal use of the bushing assembly 22, the bushing pin 50 is secured within the bushing housing through hole 184 by the bushing sleeve 54.

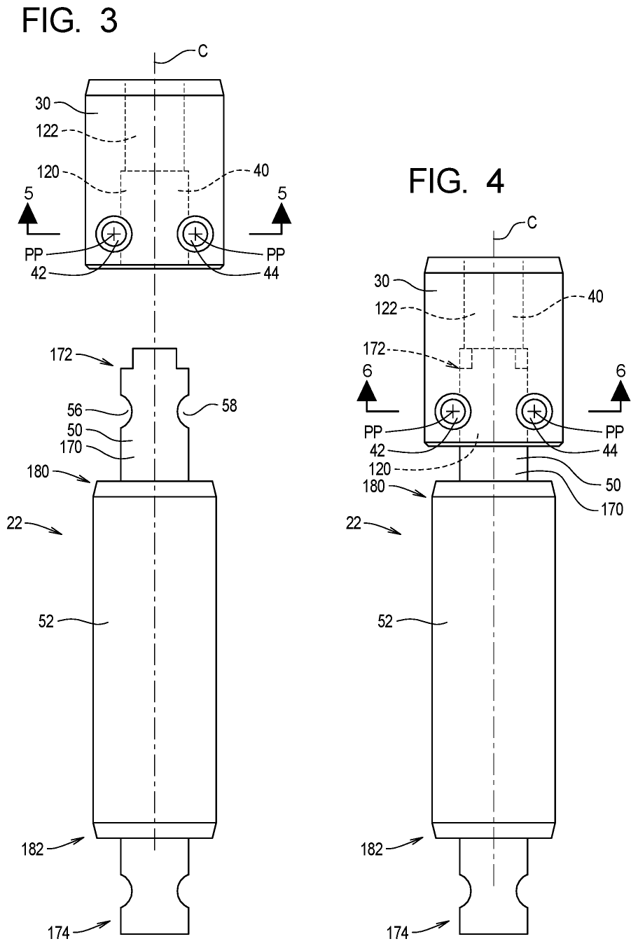

To use the first example coupler assembly, the proximal end 172 of the bushing pin 50 is inserted into the coupler through hole 40 as shown in FIGS. 3 and 4 until the first and second bushing pin recesses 56 and 58 are in a desired orientation relative to the first and second coupler pin passageways 42 and 44 as shown in FIG. 4. The first and second coupler pin assemblies 32 and 34 are then inserted into the first and second coupler pin passageways 42 and 44 as shown in FIGS. 5-7 until at least a portion of the first and second coupler pin assemblies 32 and 34 is within the first and second bushing pin recesses 56 and 58. At this point, the O-rings 152 engage the second transition surfaces 142 to inhibit withdrawal of the first and second coupler pin assemblies 32 and 34 from the first and second coupler pin passageways 42 and 44. However, the first and second coupler pin assemblies 32 and 34 can be withdrawn from the first and second coupler pin passageways 42 and 44 by deliberate application of force.

With the proximal end 172 of the bushing pin 50 within the coupler through hole 40 and the first and second coupler pin assemblies 32 and 34 within the first and second coupler pin passageways 42 and 44, the first and second coupler pin assemblies 32 and 34 engage the bushing pin 50 at the first and second bushing pin recesses 56 and 58 to inhibit movement of the bushing pin 50 relative to the coupler collar 30 along the coupler axis C. Force applied to the coupler collar 30 along the coupler axis C will thus be transmitted to the bushing pin 50.

The bushing pin 50 may be removed from the bushing housing 52 by anchoring or bracing the bushing housing 52 in place while a force is applied to the coupler collar 30 along the coupler axis C. Any system or method for anchoring or bracing the bushing housing 52 and applying a force to the coupler collar 30 along the coupler axis C may be used.

The example displacement system 24 as illustrated in FIGS. 9-12 may be used to apply a force is applied to the coupler collar 30 along the coupler axis C while anchoring or bracing the bushing housing 52 as shown in FIGS. 8-12. The example displacement system 24 comprises an actuator system 220 and a brace member 222. The example actuator assembly 220 comprises an actuator housing 230, and actuator piston 232, an actuator rod 234, and an actuator nut 236. The example actuator housing 230 and example actuator piston 232 define an actuator chamber 240 into which pressurized fluid may be introduced through an actuator inlet 242. The example actuator rod 234 defines a first rod end 250 and a second rod end 252. The first rod end 250 is threaded to engage the threaded portion 122 of the coupler collar 30, and the second rod end 252 is threaded to engage the actuator nut 236.

A diameter of the example bushing housing 52 is smaller than a diameter of the coupler collar 30, so the example brace washer 222 is arranged over the bushing pin 50 between the bushing housing 52 and the coupler collar 30 as shown in FIGS. 8-12. The first rod end 250 is then threaded into the threaded portion 122 of the coupler collar 30. The actuator system 220 is then formed by inserting the second rod end 252 through the actuator housing 230 and actuator piston 232 as shown in FIGS. 9 and 10. The actuator nut 236 is then threaded onto the second rod end 252 as shown in FIGS. 10 and 11. The displacement system 24 is then operated by introducing pressurized fluid into the actuator chamber 240 through the actuator inlet 242 such that the pressurized fluid forces the actuator piston 232 out of the actuator housing 230 as shown by a comparison FIGS. 11 and 12. The actuator piston 232 acts on the actuator rod 234 through the actuator nut 236 such that the actuator rod 234 displaces the coupler assembly 20, and the bushing pin 50 secured thereto. Reaction forces are applied from the bushing housing 52 to the actuator housing 230 through the brace washer 222. Continued operation of the displacement system 24 forces or pulls the bushing pin 50 out of the bushing housing 52 as shown in FIG. 13.

What is claimed is:

1. A coupler assembly for engaging a bushing pin of a bushing assembly, the bushing pin defining at least one bushing pin recess, the coupler assembly comprising:
a coupler collar defining a coupler through hole and at least one coupler pin passageway; and
at least one coupler pin adapted to be inserted at least partly through the at least one coupler pin passageway; wherein
with at least a portion of the bushing pin within the coupler through hole and the at least one bushing pin recess in a desired orientation relative to the at least one coupler pin passageway, the at least one coupler pin is inserted into the at least one coupler pin passageway such that the at least one coupler pin engages the at least one bushing pin recess to inhibit relative movement between the bushing pin and the coupler collar.

2. A coupler assembly as recited in claim 1, in which:
the coupler collar defines a plurality of coupler pin passageways;
the at least one coupler pin comprises a plurality of coupler pins; and
with at least a portion of the bushing pin within the coupler through hole and the at least one bushing pin recess in a desired orientation relative to the at least one coupler pin passageway, each of the plurality of coupler pins is inserted into one of the plurality of coupler pin passageways such that each of the plurality of coupler pins engages one of the at least one bushing pin recesses to inhibit relative movement between the bushing pin and the coupler collar.

3. A coupler assembly as recited in claim 1, in which:
the coupler collar defines first and second coupler pin passageways;
the at least one coupler pin comprises first and second coupler pins; and
with at least a portion of the bushing pin within the coupler through hole and the at least one bushing pin recess in a desired orientation relative to the at least one coupler pin passageway, the first and second coupler pins are inserted into the first and second coupler pin passageways, respectively, such that each of the first and second coupler pins engages one of the at least one bushing pin recesses to inhibit relative movement between the bushing pin and the coupler collar.

4. A coupler assembly as recited in claim 1, in which the at least one coupler pin is detachably attached to the coupler collar.

5. A coupler assembly as recited in claim 4, further comprising at least one resilient member arranged to detachably attach the at least one coupler pin to the coupler collar.

6. A coupler assembly as recited in claim 4, further comprising at least one resilient member, in which:
the at least one resilient member is detachably attached to the coupler pin;
a projection formed on the coupler collar extends into the at least one coupler pin passageway; and
the resilient member is arranged to engage the projection to detachably attach the coupler pin to the coupler collar.

7. A method of removing a bushing pin defining at least one bushing pin recess from a bushing assembly, the method comprising the steps of:
providing a coupler collar defining a coupler through hole and at least one coupler pin passageway; and
providing at least one coupler pin adapted to be inserted at least partly through the at least one coupler pin passageway; and
with at least a portion of the bushing pin within the coupler through hole and the at least one bushing pin recess in a desired orientation relative to the at least one coupler pin passageway, inserting the at least one coupler pin into the at least one coupler pin passageway such that the at least one coupler pin engages the at least one bushing pin recess to inhibit relative movement between the bushing pin and the coupler collar.

8. A method as recited in claim 7, in which:
the step of providing the coupler collar comprises the step of defining a plurality of coupler pin passageways;
the step of providing the at least one coupler pin comprises the step of providing a plurality of coupler pins; and
with at least a portion of the bushing pin within the coupler through hole and the at least one bushing pin recess in a desired orientation relative to the at least one coupler pin passageway, inserting each of the plurality of coupler pins into one of the plurality of coupler pin passageways such that each of the plurality of coupler pins engages one of the at least one bushing pin recesses to inhibit relative movement between the bushing pin and the coupler collar.

9. A method as recited in claim 7, in which:
the step of providing the coupler collar comprises the step of defining first and second coupler pin passageways;
the step of providing the at least one coupler pin comprises the step of providing first and second coupler pins; and
with at least a portion of the bushing pin within the coupler through hole and the at least one bushing pin recess in a desired orientation relative to the at least one coupler pin passageway, inserting the first and second coupler pins into the first and second coupler pin passageways, respectively, such that each of the first and second coupler pins engages one of the at least one bushing pin recesses to inhibit relative movement between the bushing pin and the coupler collar.

10. A method as recited in claim 7, further comprising the step of detachably attaching the at least one coupler pin to the coupler collar.

11. A method as recited in claim 10, further comprising the step of arranging at least one resilient member to detachably attach the at least one coupler pin to the coupler collar.

12. A method as recited in claim 10, further comprising the steps of:
providing at least one resilient member;
detachably attaching the at least one resilient member to the coupler pin;
forming a projection on the coupler collar such that the projection extends into the at least one coupler pin passageway; and
arranging the resilient member to engage the projection to detachably attach the coupler pin to the coupler collar.

13. A method as recited in claim 7, further comprising the step of displacing the coupler collar relative to the bushing assembly to remove the bushing pin from the bushing assembly.

14. A system for removing a bushing pin defining at least one bushing pin recess from a bushing assembly comprising a bushing housing, the system comprising:
a coupler collar defining a coupler through hole and at least one coupler pin passageway;
at least one coupler pin adapted to be inserted at least partly through the at least one coupler pin passageway; and
an actuator; wherein
with at least a portion of the bushing pin within the coupler through hole and the at least one bushing pin recess in a desired orientation relative to the at least one coupler pin passageway, the at least one coupler pin is inserted into the at least one coupler pin passageway such that the at least one coupler pin engages the at least one bushing pin recess to inhibit relative movement between the bushing pin and the coupler collar; and
the actuator is operated to displace the coupler relative to the bushing housing to remove the bushing pin from the bushing assembly.

15. A system as recited in claim 14, in which:
the coupler collar defines a plurality of coupler pin passageways;
the at least one coupler pin comprises a plurality of coupler pins; and
with at least a portion of the bushing pin within the coupler through hole and the at least one bushing pin recess in a desired orientation relative to the at least one coupler pin passageway, each of the plurality of coupler pins is inserted into one of the plurality of coupler pin passageways such that each of the plurality of coupler pins engages one of the at least one bushing pin recesses to inhibit relative movement between the bushing pin and the coupler collar.

16. A system as recited in claim 14, in which:
the coupler collar defines first and second coupler pin passageways;
the at least one coupler pin comprises first and second coupler pins; and
with at least a portion of the bushing pin within the coupler through hole and the at least one bushing pin recess in a desired orientation relative to the at least one coupler pin passageway, the first and second coupler pins are inserted into the first and second coupler pin passageways, respectively, such that each of the first and second coupler pins engages one of the at least one bushing pin recesses to inhibit relative movement between the bushing pin and the coupler collar.

17. A system as recited in claim 14, in which the at least one coupler pin is detachably attached to the coupler collar.

18. A system as recited in claim 17, further comprising at least one resilient member arranged to detachably attach the at least one coupler pin to the coupler collar.

19. A system as recited in claim 17, further comprising at least one resilient member, in which:
the at least one resilient member is detachably attached to the coupler pin;
a projection formed on the coupler collar extends into the at least one coupler pin passageway; and
the resilient member is arranged to engage the projection to detachably attach the coupler pin to the coupler collar.
